(19) United States
(12) Patent Application Publication
(10) Pub. No.: US 2021/0172629 A1
(43) Pub. Date: Jun. 10, 2021

(54) METHODS AND SYSTEMS FOR MANAGING AIRFLOW AND CONTAMINATION IN LOADING STATIONS AND CHUTES OF TRANSPORT SYSTEMS

(71) Applicant: Eric Pollock, Denver, CO (US)

(72) Inventor: Eric Pollock, Denver, CO (US)

(21) Appl. No.: 17/118,360

(22) Filed: Dec. 10, 2020

Related U.S. Application Data
(60) Provisional application No. 62/946,184, filed on Dec. 10, 2019.

(51) Int. Cl. F24F 7/06; B65F 5/00; E04F 17/12

(52) U.S. Cl. CPC F24F 7/06; B65G 11/026; E04F 17/12; B65F 5/005

(57) ABSTRACT

Methods and system for waste collection and transport systems are provided. Systems of the present disclosure comprise a loading station providing a point of ingress and storage for materials into a larger system. The chute may temporarily house materials. Venting features are provided wherein the chute or load station is provided in fluid communication with an additional component of the system or an exterior environment.

This U.S. Non-Provisional Patent Application claims the benefit of priority from U.S. Provisional Patent Application Ser. No. 62/946,184 filed Dec. 10, 2019, the entire disclosure of which is hereby incorporated by reference.

### FIELD

The present disclosure relates generally to collection and transport systems. These systems include, but are not limited to, vacuum waste collection systems. In some embodiments, the present disclosure relates to chutes and loading stations for systems including but not limited to those used for transporting trash, linen, and recyclables.

### BACKGROUND

Vacuum waste collection systems and similar systems are useful for safely and efficiently transporting materials. Such systems are known to be used for transporting materials such as waste, linens, recycling, and other objects from point to point. The systems typically convey materials between different locations in a building, a development, or other interconnected space.

In various systems including, but not limited to vacuum waste collection and transport systems, entry points or “loading stations” are provided as a means of ingress for materials into the system. In some embodiments, loading stations are connected to and feed material to a storage chamber or chute. The storage chamber or chute receives, and occasionally stores materials prior to delivery of the materials into a transport pipe. Vacuum collection systems and chutes are commonly used in commercial buildings like hospitals, apartments, etc. to transport waste, recycling and/or dirty linens. Material in systems and chutes has been known to cause odors and harbor pathogens. This risk is enhanced when at least one of the size of a chute and the duration over which material is to be housed within the chute before entering a transport pipe is increased.

It is occasionally desirable to increase the size of a chute or the holding time of materials, which provides a side effect of increasing odors and risks of pathogens. Regardless of system specification, chute size, etc., it is desirable to reduce odors, pathogens, and risks associated therewith.

### SUMMARY

There has been a long-felt but unmet need to provide methods and systems for managing and treating air quality within systems. There has further been a need to manage, treat, and remove contaminated air from load stations, and storage chambers of systems wherein air and materials are known to be housed, stored or otherwise stagnate even for brief periods of time. Embodiments of the present disclosure provide systems, devices and methods that decrease the risk of the transmission of pathogens and minimize odors within systems.

In some embodiments, at least one of a chute and a loading station for a waste, recycling, and/or linen transport system is provided with venting or ventilation features. In some embodiments, at least one of the chute and the loading station comprises an aperture or hole in a temporary storage area of the system (e.g. a storage chamber of the loading station). A tube or conduit is provided that provides the chute or loading station in fluid communication with an additional component of the system such as a transport tube of the system that is intended to handle materials, pathogens, contaminated air, etc. In preferred embodiments, the ventilation feature of the system including the tube or conduit is operable to transfer or convey fluid (e.g. air) to the transport pipe due to a negative pressure differential between the storage chamber and the transport pipe. In such embodiments, the ventilation system comprises a passive system that provides air flow from the storage chamber (or similar) to the transport pipe. In alternative embodiments, it is contemplated that one or more air movers are provided to transfer or assist in transferring fluid from the loading station or chute to the transport pipe. Air movers are contemplated as comprising, but are not limited to, fans and pumps.

Loading stations and related features for systems are shown and described, for example, in U.S. Patent Application Publication No. 2019/0291974 to Archambault, the entire disclosure of which is hereby incorporated by reference for all purposes.

In some embodiments, one or more outlets, apertures, holes, or similar means of egress are provided to convey fluid from a storage chamber or loading station and are provided in fluid communication with an outlet or secondary source. For example, in some embodiments, a storage chamber of a chute or loading station is provided in fluid communication with an outside environment or a secondary storage chamber for treatment of air and fluid.

In certain embodiments, a plurality of fluid channels are provided and each of the fluid channels comprise a conduit or means for fluid communication between a first component of a system and a second component of the system. In some embodiments, the first component is contemplated as comprising at least one of a loading station, a queue chute, and a storage chamber, and the second component is contemplated as comprising a transport pipe with at least one of an airflow and a negative pressure provided therein (at least relative to the first component). One or more of the plurality of fluid channels comprise passive fluid flow conduits that allow fluid to flow under a pressure differential. In some embodiments, one or more air movers are provided to facilitate airflow.

In preferred embodiments, apertures or vent openings provided in systems of the present disclosure comprise relatively small openings (at least relative to the diameter of a chute or transport pipe). For example, in some embodiments, it is contemplated that an air outlet for venting from a loading station comprises a hole with a diameter of between approximately 0.5 inches and 5.0 inches. It will be recognized that the present disclosure is not limited to circular apertures of tubular venting members. For example, a conduit comprising a rectangular cross-section may perform the tasks and achieve the goals of the present disclosure. In preferred embodiments, the air outlet comprises a diameter or width of approximately 1.0 inches. Although no size restriction on vent openings, conduits, etc. is provided herewith, it is preferred that such opening comprises a relatively small size so as to prevent materials from passing through the vent feature and thereby circumventing the chute through which materials are intended to travel. In some embodiments, it is contemplated that a mesh filter, netting, or grate is provided over or in association with an airflow aperture of the present disclosure to prevent materials from entering and becoming lodged in a venting conduit. In such embodiments, a light sensor or similar feature is contemplated as being provided to detect a blocked grate.

In one embodiment, a system is provided that comprises a transport pipe, a loading station for selectively inputting materials into the system, and a chute with a first end and a second end. The first end is connected to the loading station and the second end is connected to the transport pipe. A vent tube is provided that comprises a first end and a second end. The first end is connected to and is in fluid communication with an internal volume of at least one of the loading station and the chute, and the second end is connected to and in fluid communication with an internal volume of the transport pipe. The vent tube is operable to convey fluid from at least one of the chute and the loading station to the transport pipe. Preferably, the vent tube is not operable and not sized to transport materials to the transport pipe, such materials being intended to be gravity fed into the chute and ultimately conveyed to the transport pipe from the chute.

In another embodiment, a system is provided that comprises a transport pipe, a loading station for selectively inputting materials into the system, and a chute with a first end and a second end. In some embodiments, and as will be recognized by one of skill in the art, a throat, loading chute or queue chute and a loading station entrance may collectively be considered a “loading station”. In preferred embodiments, a first end of the chute is connected to the loading station door and the second end is connected to the transport pipe. The loading station thus extends between an outer door that is accessible to or by a user and an inner door that comprises a gate between a throat and a main transport pipe. The entire loading station comprises a pressure that is reduced or less than a pressure within the main transport pipe at least when the system is provided in operation.

In some embodiments, a door or gate is provided between a loading station and a transport pipe that comprises a fluid permeable member. A negative pressure (relative to the loading station) associated with the transport pipe draws airflow from the loading station through the gate and prevents or reduces build-up of bad air and pathogens in the loading station. The door, closure or gate is contemplated as comprising one or more holes, or bars or mesh, such that solid materials of a certain size in the chute are unable to pass through the gate, but fluid flow through the closure, door or gate is allowed. A fluid flow condition is thereby established wherein fluid (e.g. air) in the loading station is constantly or near-constantly drawn into a transport pipe of the system that comprises a lower pressure than the station and chute.

In some embodiments, loading stations and/or queue chutes of the present disclosure are provided in fluid communication with an indoor environment. For example, in some embodiments, a loading station door or other component comprises an air inlet that is operable to transmit air from a room in which the loading station resides into the interior of the loading station. As one of ordinary skill in the art will recognize, loading stations of the present disclosure will be provided with air-admittance at various times due to the periodic opening of the loading station door. In some embodiments, however, it is also contemplated that an air admittance feature is provided to prevent a pressure within the loading station and/or queue chute from reaching values that would prevent or complicate the opening of a door of the loading station.

In a further embodiment, a system is provided that comprises a transport pipe and at least one loading station for selectively inputting materials into the system. The loading station comprises a first door, a loading chute, and a throat. The loading station is separated from a transport pipe of the system by a door or gate. The door or gate separates the loading station from the transport pipe. In some embodiments, the inner door is connected to the outer door by a common hinge and can include a rotating trough-style door. Upon closing the hinged door, fluid flow is prevented from travelling from the loading station to an interior environment. In some embodiments, the inner door is contemplated as being hermetically sealed against the entrance of the chute.

In another embodiment, a system is provided that comprises a transport pipe, a loading station for selectively inputting materials into the system, and wherein the loading station comprises a queue chute with a first end and a second end. The first end of the queue chute is connected to a loading station entrance with a door and the second end is connected to the transport pipe. An operable gate is located at the second end of the queue chute that prevents materials from passing into the transport pipe unless the gate is opened. The gate comprises a fully opened position and an at least partially closed position. In the partially closed position, a gap is provided between the gate and the system to allow air to flow into a transport pipe while substantially preventing passage of solid materials into the transport pipe.

Additionally, embodiments of the present disclosure are contemplated as comprising a vent or a one-way valve associated with the loading station. The one-way valve is oriented such that air may flow into a transport pipe from a loading station, but may not flow out of the transport pipe into the loading station. Further, the vent may be machine operable and operated on a timer.

In various embodiments, methods of operating a system are provided. In one embodiment, a method of operating a system is provided that comprises providing a transport pipe; a loading station door for selectively inputting materials into the system; a chute with a first end and a second end, the first end connected to the loading station door and the second end connected to the transport pipe; a vent tube is provided that comprises a first end and a second end, the first end connected to and in fluid communication with an internal volume of the loading station, and the second end connected to and in fluid communication with an internal volume of the transport pipe. The vent tube is operable to convey fluid from the loading station to the transport pipe, even when the loading station is not in active use (e.g. being emptied), and fluid is allowed to flow from the loading station to the transport pipe at least when the loading station door is provided in a closed position.

In other embodiments, methods of operating the system described above include further steps. In some embodiments, an operable vent or valve may be provided on the front of the loading station door or proximal thereto. The vent or valve may be operated by a controller and timer. Specifically, the controller may be used to open the vent or valve at set intervals to replace the air in the loading station and chute with fresh air from outside the loading station.

In further embodiments, methods of operating a gate or door that permits materials to enter a main transport pipe are provided. This gate starts at a closed position that prevents materials from entering the transport pipe while still allowing air to pass through the gate into the transport pipe. The gate is then fully opened to allow the materials to be emptied into the transport pipe. The gate is then closed again to the closed position.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

### DESCRIPTION OF THE DRAWINGS

FIG. 1 is a perspective view of a loading station door and chute according to one embodiment of the present disclosure.

FIG. 2 is a detailed perspective view of the loading station door and the chute according to the embodiment of FIG. 1.

FIG. 3 is a side view of a loading station door and chute according to one embodiment of the present disclosure.

FIG. 4 is a side view of a loading station and chute according to one embodiment of the present disclosure having a partially opened gate.

FIG. 5 is a side view of a loading station and chute according to one embodiment of the present disclosure having controller operated components.

FIG. 6A is a side view of a loading station and chute according to one embodiment of the present disclosure.

FIG. 6B is a side view of a loading station as shown in FIG. 6A in which the load station door is closed.

FIG. 6C is a side view of a loading station as shown in FIG. 6A in which the load station door is open.

FIG. 6D is a side view of a loading station having a protrusion on the loading station door.

FIG. 6E is a side view of a loading station as shown in FIG. 6D having an open loading station door.

FIG. 7A is a side view of a loading station and chute according to one embodiment of the present disclosure.

FIG. 7B is a front elevation view of a gate as shown in FIG. 7A.

FIG. 8 is a side view of a loading station and chute according to one embodiment of the present disclosure having a vent.

FIG. 9 is a side view of a loading station and chute according to one embodiment of the present disclosure.

FIG. 10 is a side view of a loading station and chute according to one embodiment of the present disclosure having a fan attached to the system.

### DETAILED DESCRIPTION

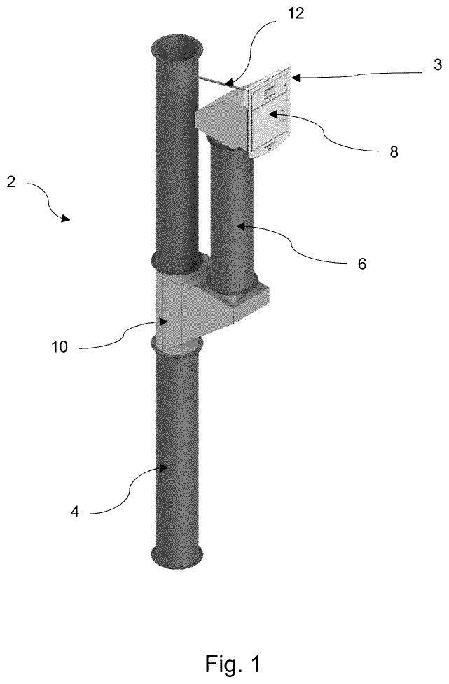

FIG. 1 is a perspective view of a system 2 with a loading station door 8 and a loading station receiving area 3. The loading station further comprises a chute 6, which may be referred to herein as a “queue chute” or “loading chute”. As shown, the system 2 comprises a main transport pipe 4 intended to be provided with a pressure and/or airflow and transport materials including, but not limited to trash, recyclables, linens and similar materials. Although not shown in FIG. 1, materials are intended to be conveyed through the transport pipe 4 to an end destination or collection facility. It will be recognized that only a portion of a larger system is shown in FIG. 1, and systems will typically and preferably comprise a plurality of transport pipes and a plurality of loading stations.

Materials are provided to the transport pipe 4 via a chute 6. The chute 6 comprises an entry-point depicted in FIG. 1 as a loading station door 8. The loading station door 8 is contemplated as comprising various features including, for example, a secure door, security features (e.g. keypad or scanner), but no limitation is provided herein with respect to a particular type of loading station. The loading station door 8 is secured to and provides an access point for loading materials into the chute 6. The chute is in selective communication with the transport pipe 4 via a throat 10, and the throat 10 comprises a door or gate in various embodiments. The chute 6 and loading station door 8 comprise an interior volume in which materials may be loaded and temporarily stored prior to releasing the materials into the transport pipe 4. For example, materials may be loaded into the chute 6 with the door of the loading station 8 in an open position and the gate closed. The door of the loading station door 8 may then be closed, and the gate may be subsequently opened to safely and securely release materials into the transport pipe for conveyance to various locations. Although preferred embodiments of the present disclosure contemplate a door or gate provided between the throat and the transport pipe, alternative embodiments are contemplated that do not comprise a door or gate at this location. Such embodiments include, for example, a loading station door 8 as the means to seal or access the loading station; as well as arrangements where a second loading station door is provided closer to the first door 8.

Applicant has recognized that the storage and collection of materials a loading station (generally defined as comprising a queue chute 6, a door 8, and a throat 10) provides various complications including, for example, a build-up of odor and a potential breeding ground for pathogens (particularly in hospital settings). These complications and risks thereof increase as the interior volume of the chute 6 and loading station door 8 are increased. Accordingly, embodiments of the present disclosure are provided that comprise a vent tube or channel 12 that places the interior volume of the loading station in fluid communication with the transport pipe 4. Fluid (e.g. air) is drawn from the interior volume loading station directly into the transport pipe 4 which is intended to handle soiled and/or hazardous materials and which is generally not accessible to a user. In the depicted embodiment of FIG. 1, a vent channel 12 comprises a straight pipe or channel of relatively small diameter (e.g. 1.0″) to vent or convey fluid from the receiving area 3 of the loading station to the transport pipe 4.

In operation, the loading station door 8 may often be provided in a state of non-use. In such a state, the loading station door 8 is closed and inactive. The gate or door provided between the throat 10 and the transport pipe 4 may also be closed. The system is thus not moving materials from the loading station to the transport pipe, but fluid is flowing through the transport pipe 4. In such a situation (among others), the vent channel 12 provides a means for venting, fluid flow, and egress of odors and contaminated air into the transport pipe such that build up does not occur within the chute 6 or other parts of the loading station. It will be recognized, however, that venting and operation of the vent channel 12 is not limited to this situation or state of use of a system.

In some embodiments, it is contemplated that one or more one-way valves are provided in the vent channel. For example, it is contemplated that a one-way valve is provided at the junction of the vent channel 12 and the transport pipe 4 to prevent flow of air and materials from the transport pipe 4 into the vent channel 12. It will be recognized that a pressure within the transport pipe 4 will typically be below a pressure in the internal volume of the loading station (which may vary but is at least occasionally at or near atmospheric pressure due to the door and access to the outside environment). Accordingly, materials, fluids and pathogens are not likely to migrate or transmit from the transport pipe 4 to the vent channel 12. However, embodiments of the present disclosure contemplate enhanced protection from such risks by providing one or more one-way valves.

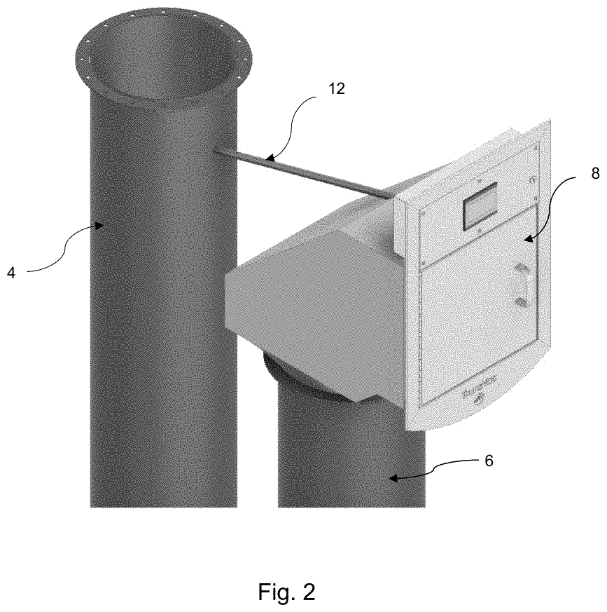

FIG. 2 is a detailed view of the system of FIG. 1 and showing the transport pipe 4 and the vent channel 12. Although the vent channel 12 of the embodiment of FIG. 2 comprises a straight pipe or tube, no limitation is provided herein with respect to size, length, shape or orientation of the vent channel 12. For example, in some embodiments, pipe with one or more bends are provided as the vent channel 12. Additionally, while the vent channel 12 is shown as being provided between the loading station entrance 3 and the transport pipe 4, alternative arrangements are contemplated. For example, in addition to or in lieu of the vent channel 12 shown in FIG. 2, conduits or vent channels can be provided that connect to and extend between the chute 6 and the transport pipe 4, and/or channels are provided extend from at least one of the chute 6 and the loading station entrance 3 and an external environment (e.g. an exterior ventilation system).

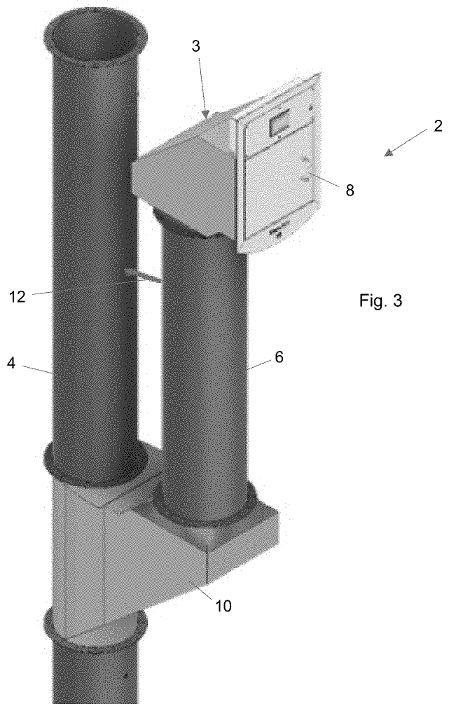

FIG. 3 depicts a system according to another embodiment of the present disclosure. As shown, a vent channel 12 is provided between the chute 6 and the transport pipe 4. Air from the loading station, including the chute 6 and the throat 10 is drawn through the vent channel 12 and into the transport pipe 4. Vent channels 12 of the present disclosure are contemplated as being provided in various locations in a system while achieving the result and providing the benefit of drawing foul or contaminated air away from a loading station.

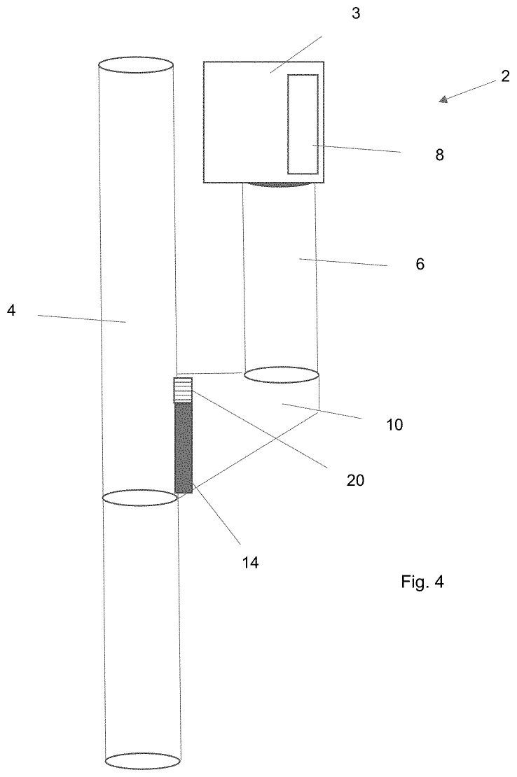

FIG. 4 is a side elevation view a further embodiment of a system 2. As shown, the loading station comprises a door 8, a chute 6, and a throat 10. A gate 14 is provided at an intersection of the throat 10 and a material transport pipe 4.

In the embodiment of FIG. 4, the gate 14 is operated to allow constant airflow away from the loading station. The gate 14 has two operating positions, a closed position, and an open position. In the closed position, the gate 14 blocks material from the loading station entering the transport pipe 4. The gate 14 comprises an opening 20 preferably at an upper end of the gate 14. The opening 20 allows air to flow through from the loading station into the transport pipe 4. When the gate 14 is opened, the materials from the loading station may be emptied from the chute 6 and/or throat 10 into the transport pipe 4.

The opening 20 may be as small as ⅛ inch or as large as 12 inches depending on the size of the throat 10, the kind of items being disposed of, and the amount of items present in the throat 10. For example, if the gate 14 is located in a throat 10 having a height of three feet, the gate 14 may be opened up to a foot if there are bags of trash being disposed of. However, if the trash is unbagged, the gate 14 will only be opened a slight amount to prevent any trash from prematurely entering the transport pipe 4 through the opening 20. Thus, the opening 20 is large enough to allow air to freely flow through the opening 20, but not large enough to allow materials to enter the transport pipe 4.

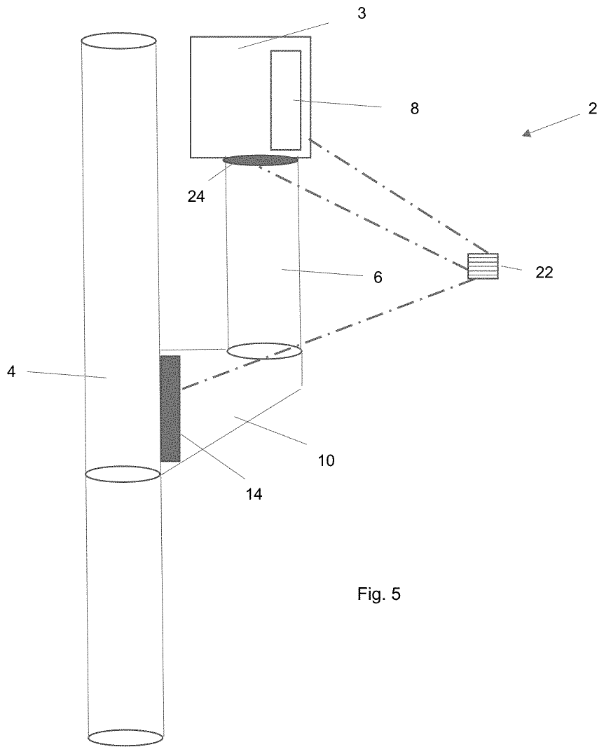

In FIG. 5, a further embodiment of the system 2 is shown. In this embodiment, the system 2 comprises a transport pipe 4, a loading station comprising a loading station door 8, a loading station entrance area 3, a chute 6, and a throat 10. A gate 14 is provided that prevents materials accumulated in the throat 10 and the chute 6 from prematurely entering the transport pipe 4. Additionally, a programmable controller 22 is provided in connection with the gate 14, the loading station door 8, and a chute door 24.

The controller 22 is programmed to operate the gate 14 and/or the chute door 24. The controller 22, can operate based on any desired programmable criteria. For instance, the controller may routinely open the gate 14 and/or the chute door 24 at certain intervals or set times. The controller may fully open the gate 14 and the chute door 24, or they may be only partially opened as described in FIG. 4. Alternatively, the controller may receive signals from other electronic features, such as motion detectors, optical sensors, audio sensors, or other sensors known in the art. In these embodiments, the other electronic features would detect light, sound, or motion and send a signal to the controller which would then cause the gate 14 and/or the chute door 24 to open. Thus, when the user opens the loading station door 8, the air in the loading station has already begun to be replaced such that there is no accumulation of odors or pathogens as these are flowing away from the loading station.

The above embodiment, shown in FIG. 5, prevents a constant suction loss in the transport pipe 4. By only sporadically opening the gate 14 and/or the chute door 24, there is not a constant pressure gain in the transport pipe 4 from these sources. This embodiment can reduce the operating cost of the transport system 2 by reducing the power required to generate the requisite pressure while still preventing the backflow of air when the loading station door 8 is opened.

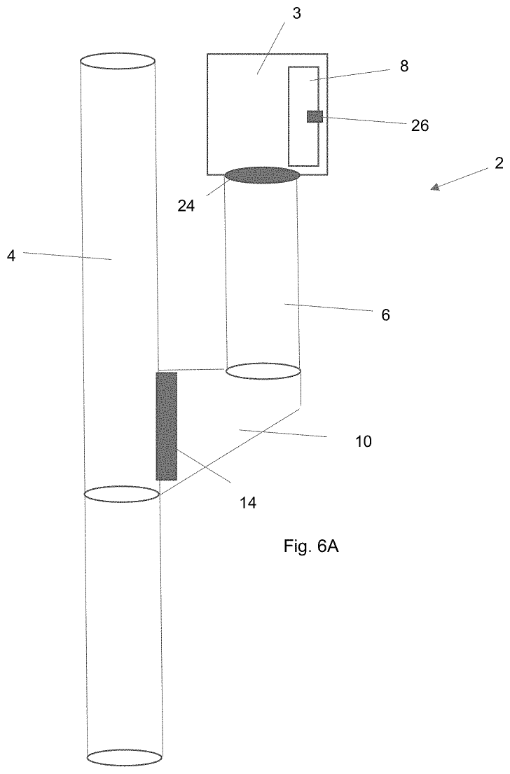

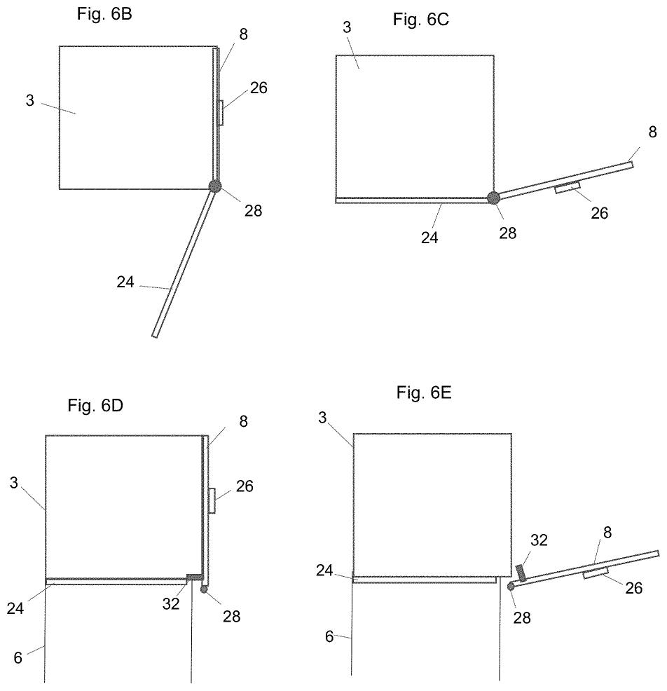

FIG. 6A depicts a system according to one embodiment of the present disclosure. As shown, the system 2 comprises a transport pipe 4, a loading station with a door 8 and a handle 26, a queue chute 6 with an inner door 24, and a throat 10 with a gate or door 14 between the throat and the transport pipe 4. Airflow in the system and access to various portions of the system 2 are controlled and enabled as shown and described herein. Various systems and embodiments are contemplated that do not comprise the inner door 24 of FIG. 6A.

In some embodiments, including that shown in FIGS. 6A-6B, a chute door 24 is connected to the loading station door 8. In the embodiment of FIGS. 6B-6C, the chute door 24 is opened when the loading station door 8 is closed. When the loading station door 8 is opened, the chute door 24 closes, preventing any air from flowing out of the chute 6. In some embodiments, the chute door 24, may form a seal against the inner wall of the chute 6 or loading station entrance area 3. This simultaneous open and closing may be accomplished through the use of a common hinge 28 that is fixedly connected to both the chute door 24 and the loading station door 8.

In some embodiments, such as the one shown in FIGS. 6D-6E, the chute door 24 is sealed against the chute 6 such that a pressure differential is created between the chute 6 and the loading station. The bottom of the loading station door 8 can have a protrusion 32 which, when in the vertical closed position, helps to form the seal between the chute door 24 and the chute 6. When the loading station door handle 26 is activated, this protrusion 32 is moved in a way that breaks the seal between the loading station and the chute 6. When the seal between the loading station and the chute 6 is broken, the air in the loading station is sucked into the chute 6 due to the vacuum created in the transport pipe 4. Thus, the air in the loading station flushes the stagnant air in the chute 6 away from the loading station and into the transport pipe 4. As the loading station door 8 is opened, fresh air from outside the loading station is then sucked into the loading station and down the chute 6 to the transport pipe 4. In this manner, the stagnant air in the chute 6 is prevented from entering the loading station.

A controller 22 may also be used to effectuate the flushing of stagnant air from the chute 6 and into the transport pipe 4. In such embodiments, the controller 22 is connected to the loading station door handle 26 as well as to the electronically operable chute door. The chute door may operate via a hinge, a sliding mechanism, interlocking halves that rotate downwards, or any other door mechanism known in the art. As in the above-described embodiment, the chute door forms a seal against the inside of the chute 6 and/or the loading station. Further, by separating the loading station from the rest of the negative pressure system, a pressure differential forms between the loading station and the chute 6.

When the controller 22 receives a signal that the loading station door handle 26 has been activated, the controller 22 sends a signal to effectuate a movement of the chute door. The movement may be to fully open the chute door 24, or it may only partially open the chute door. In either case, the seal created by the chute door 24 and the chute 6 is broken. When the seal is broken, the negative pressure of the transport pipe 2 creates a vacuum that sucks the air from the loading station entrance area 3 into the chute 6 and flushes the stagnant air in the chute 6 into the transport pipe and away from the loading station entrance area 3. While the loading station door is open, fresh air from outside the loading station 8 continues to be sucked into the system 2 by the vacuum created by the transport pipe 4. This action prevents the air in the chute 6 from entering the loading station entrance area 3.

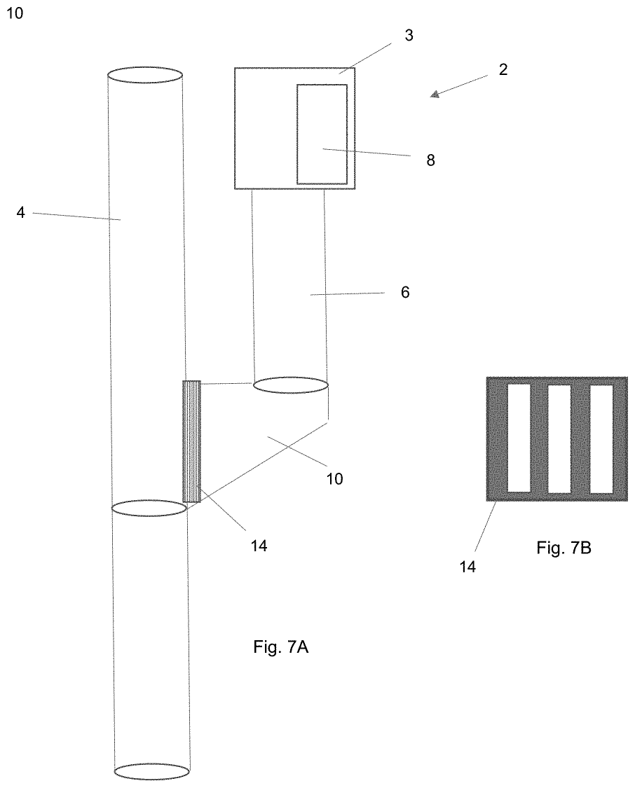

In the embodiment shown in FIG. 7A, a system 2 with an air permeable gate 14 is shown. In this embodiment, the system 2 comprises a loading station door 8, a chute 6, a throat 14, and a gate 14. The gate 14 of this embodiment is air permeable. The gate 14 can comprise bars or mesh that prevents material from entering the transport pipe 4 while still allowing air to freely flow across the gate 14. Thus, the spacing of the gate is variable and depends on the material being transported. For instance, a spacing of three inches would be acceptable for bagged trash or other larger single items; however, a smaller spacing would be required for unbagged trash, laundry, or other smaller items.

Alternatively, there may be only a portion of the gate 14 that is air permeable. For instance, in some embodiments, there is a mesh section on an otherwise solid gate 14. This embodiment provides an egress for the air into the transport pipe 4, while maintaining rigidity in the gate 14.

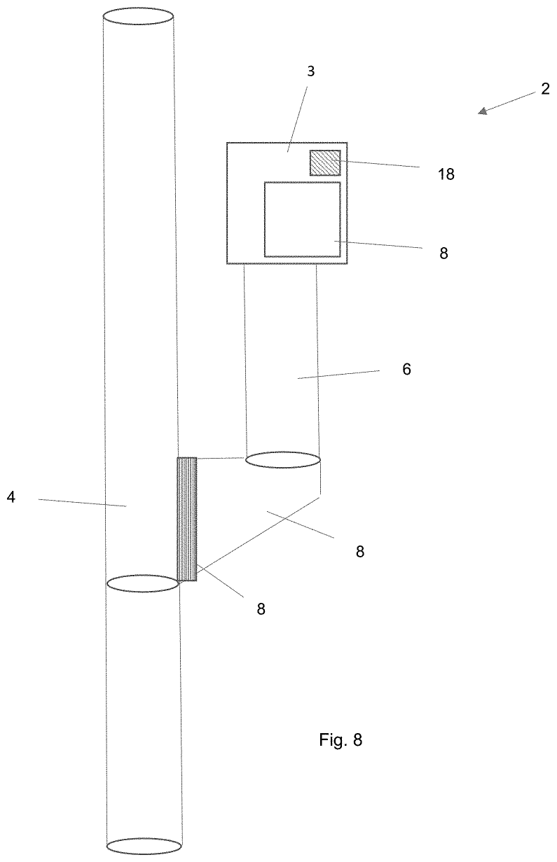

A further embodiment is shown in FIG. 8, wherein a vent or a one-way valve 18 is provided on the loading station. This embodiment allows a constant flow of fresh air into the loading station to flush the stale or otherwise contaminated air away from the loading station and into the transport pipe 4. The gate 8 of this system may be fully closed, partially opened, or it may air permeable as described in the embodiment of FIG. 7.

The valve 18 may be adjustable or set to a fixed flow rate. For embodiments with an adjustable valve 18, there may be a controller 22 that opens the valve at set intervals or times, or the valve may be opened to flush the loading station, including the chute 6, and throat 10 when a user is detected as discussed in the embodiment of FIG. 5 (for example). Alternatively, the valve 18 may be set to allow a fixed flow rate into the system 2. This flow rate may be set such that it does not significantly affect the pressure differential achieved in the transport pipe 2 while still allowing fresh air to replace the air in the chute 6 and remainder of the loading station.

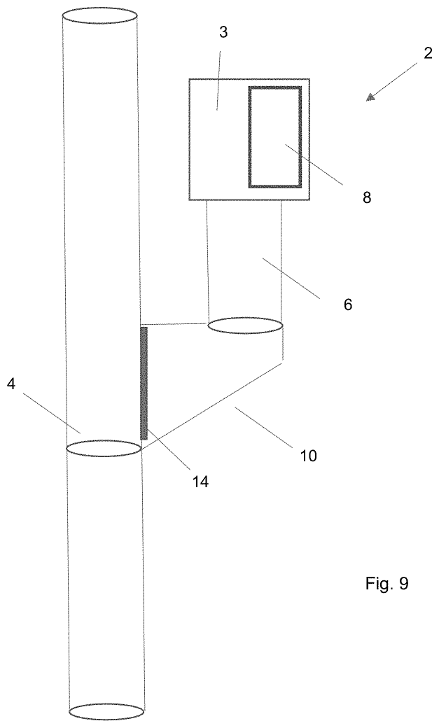

FIG. 9 shows an embodiment of the system 2 having a transport pipe 4, a throat 10 connecting the transport pipe 4 to a chute 6, and a loading station entrance area 3 with a door 8 connected to a first end of the chute 6. The loading station door 8 of this embodiment is unsealed to allow air to flow into the system from the environment at atmospheric pressure outside the loading station 8

This embodiment may benefit from features and components of earlier embodiments. Specifically, the use of an air permeable gate 14 or an opening 20. Alternatively, the vent tube 12 could be used in this system to provide a fluid pathway from the loading station to the transport pipe 4.

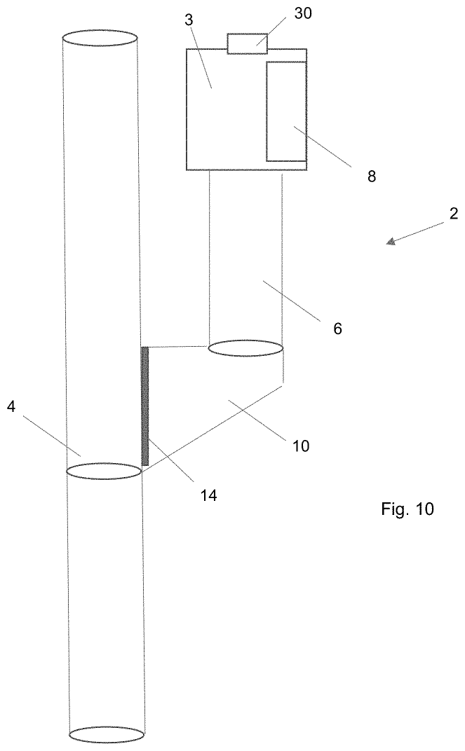

In a further embodiment shown in FIG. 10, the system 2 is similar to previously discussed embodiments and comprises a transport pipe 4, a throat 10 connecting the chute 6 to the transport pipe 4, and the chute 6 connected to a loading station entrance 3. In this embodiment, there is a fan 30 mounted to the loading station 8. While the fan 30 is shown mounted to the top of the loading station 8, the fan 30 may be mounted anywhere along the loading station 8, chute 6, or throat 10. The fan 30 may be controlled by a controller 22, a timer, or may be directly turned on and off, for example by a power switch.

This embodiment can benefit through combination with previously discussed embodiments, such as a partially opened or air permeable gate 14 or a vent tube 12 connected to the transport pipe 4. These features provide an exit for the air that is being blown into the system and thereby prevent a buildup of air that could flow out of the loading station upon opening the loading station door 8.

It is to be understood that the disclosure is not limited to particular methods or systems, which can, of course, vary. It is also to be understood that the terminology used herein is for the purpose of describing particular embodiments only and is not intended to be limiting. Further, it is to be understood that the features of the embodiments disclosed may be combined and are not mutually exclusive.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A waste collection and transport system comprising:
a transport pipe;
a loading station comprising a door for selectively inputting materials into the system and a chute;
wherein the chute extends between an area proximal to the loading station door and an entrance to the transport pipe;
a vent tube comprising a first end and a second end, the first end connected to and in fluid communication with an internal volume of the chute, and the second end connected to and in fluid communication with an internal volume of the transport pipe;
wherein the vent tube is operable to convey fluid from the chute to the transport pipe.

2. The waste collection and transport system of claim 1, wherein the first end of the vent tube is connected to an upper portion of the chute.

3. The waste collection and transport system of claim 1, wherein the vent tube comprises an internal diameter of less than 2.0 inches.

4. The waste collection and transport system of claim 1, wherein the first end of the vent tube is connected to an aperture in the chute and wherein the aperture comprises a diameter of not more than 2.0 inches.

5. The waste collection and transport system of claim 1, wherein the system comprises an air mover to move fluid through the vent tube.

6. The waste collection and transport system of claim 1, further comprising a second vent tube.

7. The waste collection and transport system of claim 1, wherein the first end of the vent tube is connected to the chute and the second end of the vent tube is connected to the transport pipe.

8. A waste collection and transport system comprising:
a transport pipe;
a loading station comprising an entrance area and a door for selectively inputting materials into the system;
a chute with a first end and a second end, the first end connected to the entrance area of the loading station and the second end connected to the transport pipe;
a vent in fluid communication with an internal volume of the chute and an internal volume of the transport pipe;
wherein the vent is operable to convey fluid from the chute to the transport pipe.

9. The waste collection and transport system of claim 8, wherein the vent comprises a tube extending between the loading station entrance area and the transport pipe.

10. The waste collection and transport system of claim 9, wherein the vent tube comprises an internal diameter of less than 2.0 inches.

11. The waste collection and transport system of claim 8, wherein the system comprises at least one of a door and a gate between the transport pipe and the chute.

12. The waste collection and transport system of claim 11, wherein the vent is provided in the at least one of a door and a gate.

13. The waste collection and transport system of claim 12, wherein the vent comprises an aperture in the at least one of a door and a gate.

14. A waste collection and transport system comprising:
a transport pipe in fluid communication with a primary air mover;
a loading station comprising a door, and entrance area, and a chute for selectively inputting materials into the system;
a vent in fluid communication with an internal volume of the loading station and an internal volume of the transport pipe;
wherein the primary air mover provides a pressure differential between the transport pipe and the loading station, the transport pipe having a reduced pressure relative to the loading station;
wherein the vent is operable to convey air from the loading station to the transport pipe.

15. The waste collection and transport system of claim 14, wherein the chute comprises a vertically transport pipe.

16. The waste collection and transport system of claim 14, wherein the vent comprises a tube extending between the chute and the transport pipe.

17. The waste collection and transport system of claim 16, wherein the vent tube comprises an internal diameter of less than 2.0 inches.

18. The waste collection and transport system of claim 15, wherein the system comprises at least one of a door and a gate between the transport pipe and the chute.

19. The waste collection and transport system of claim 15, wherein the vent comprises a conduit with a first end connected to the chute and a second end connected to the transport pipe.

20. The waste collection and transport system of claim 18, wherein the at least one of a door and a gate comprises an opening to permit airflow.
